(19) United States
(12) Patent Application Publication
(10) Pub. No.: US 2008/0078335 A1
(43) Pub. Date: Apr. 3, 2008

(54) Convertible Children's Travel Tether

(75) Inventors: Mary Jean Bush, Santa Rosa Beach, FL (US); James E. Cartabiano, Willington, CT (US)

Correspondence Address: STEVEN C. SCHNEDLER;CARTER SCHNEDLER & MONTEITH, PA, 56 CENTRAL AVE., SUITE 101, PO BOX 2985, ASHEVILLE, NC, 28802, US

(73) Assignee: Blue Ridge International Products Company, Freeport, FL (US)

(21) Appl. No.: 11/949,319

(22) Filed: Dec. 3, 2007

Related U.S. Application Data
(60) Provisional application No. 60/925,566, filed on Apr. 20, 2007.

(51) Int. Cl. A62B 35/00

(52) U.S. Cl. 119/770

(57) ABSTRACT

Convertible travel tether devices for children. A convertible tether device includes a wearable accessory suitable for extended use by a relatively older child, a harness, and a detachable tether. The detachable tether is employed when the child is relatively younger, and the wearable accessory is worn by itself when the child is relatively older without use of the tether, thus providing extended use beyond the need to use the device as a harness. When a child is tethered, the appearance of the devices encourages a child to feel as if he or she is wearing a “big boy” or a “big girl” accessory.

### CROSS-REFERENCE TO RELATED APPLICATION

The benefit of U.S. provisional patent application Ser. No. 60/925,566, filed Apr. 20, 2007 is claimed.

### BACKGROUND OF THE INVENTION

The invention relates to travel harnesses for children.

While traveling with young children, particularly in busy public places, it is often desirable to employ a harness and tether to keep a child close.

### SUMMARY OF THE INVENTION

In one aspect, a convertible travel tether device for a child is provided. The convertible tether device includes a wearable accessory suitable for extended use by a relatively older child, the wearable accessory including a harness for securing the accessory to the child, and a detachable tether. The detachable tether is employed when the child is relatively younger, and the wearable accessory is worn by itself when the child is relatively older without use of the tether.

In another aspect, a convertible travel tether device for a child is provided. The convertible tether device includes a wearable accessory suitable for extended use by a relatively older child, a harness element attachable to the accessory for securing the accessory to the child, and a detachable tether. The detachable tether is employed when a child is relatively younger, and the wearable accessory is worn by itself when the child is relatively older without use of the tether.

### BRIEF DESCRIPTION OF THE DRAWINGS

FIG. 1 is a three-dimensional view of a convertible travel tether device embodying the invention, which device includes, as an element thereof, a wearable accessory in the exemplary form of a backpack intended in particular to be worn by a boy;

FIG. 2 illustrates the backpack of FIG. 1 in use with a tether;

FIG. 3 illustrates the backpack of FIG. 1 being worn by itself, without the use of the tether;

FIG. 4 is a three-dimensional view of another convertible travel tether device, embodying the invention, which device includes, as an element thereof, a wearable accessory in the form of a girl's purse;

FIG. 5 illustrates the device of FIG. 4 in use with a tether; and

FIG. 6 illustrates the purse accessory of the FIG. 4 device being worn itself without use of the tether.

### DETAILED DESCRIPTION

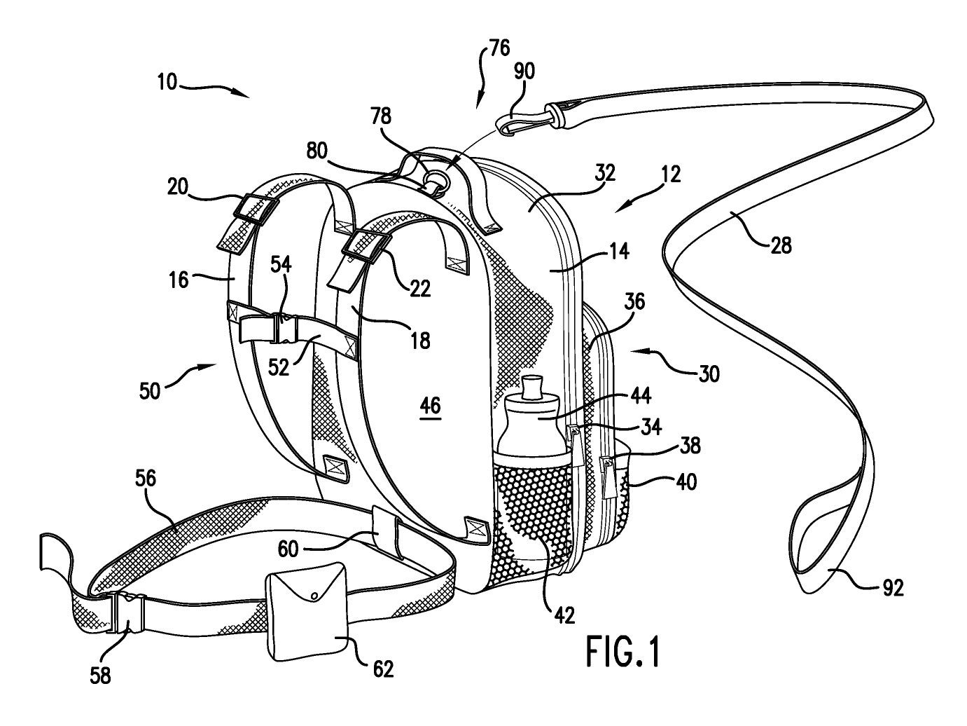

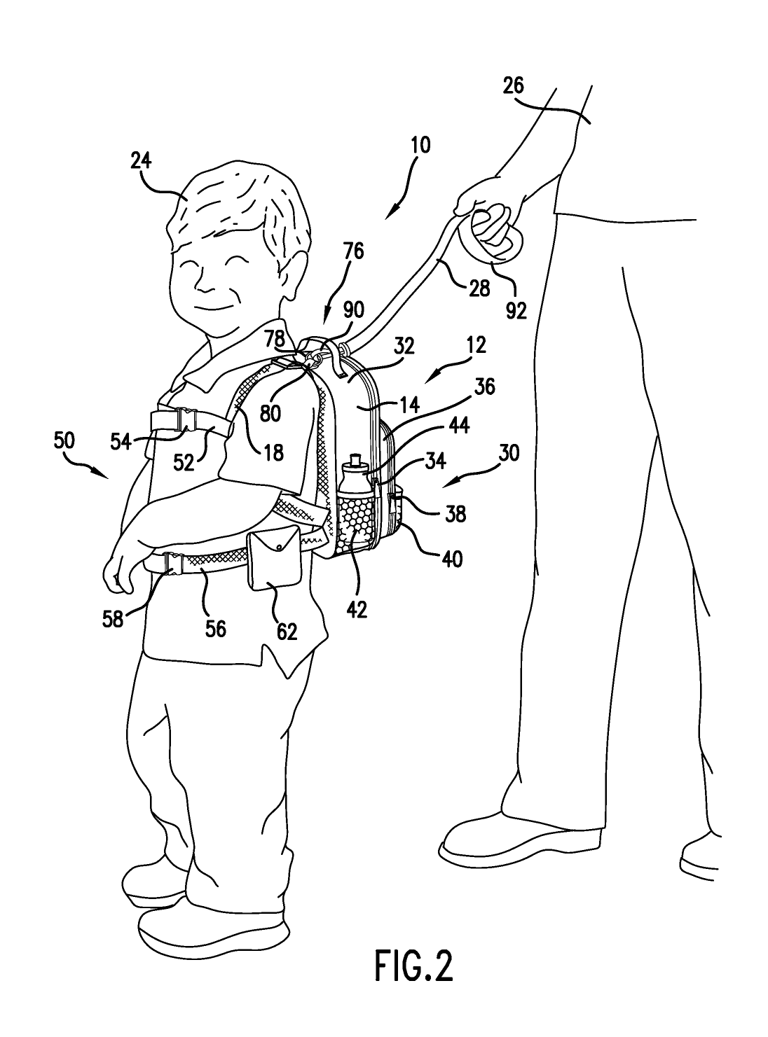

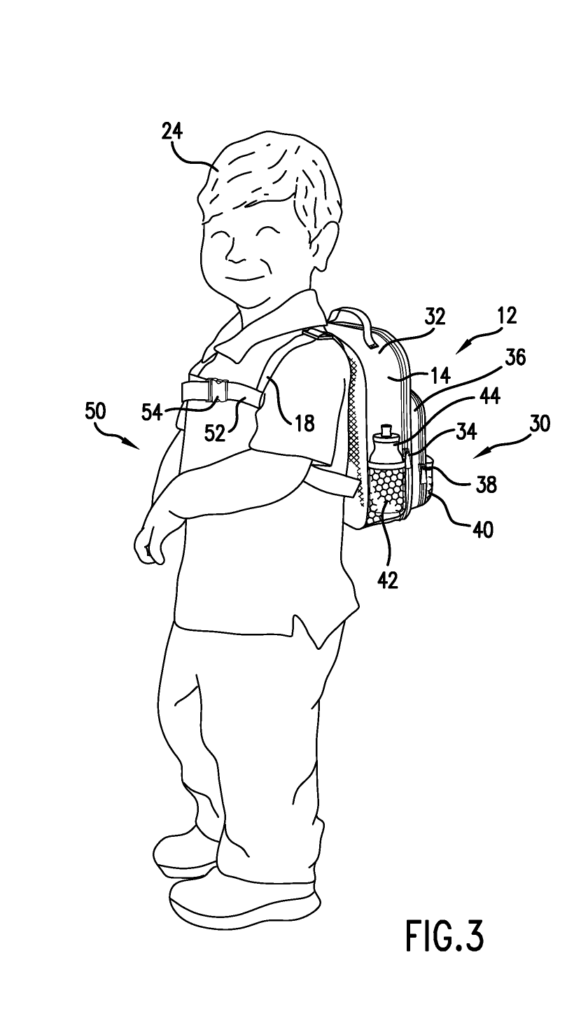

Referring first to FIGS. 1-3, a convertible travel tether device for a child is generally designated 10. The device 10 includes a wearable accessory 12 suitable for extended use by a relatively older child. In the embodiment of FIGS. 1-3, the wearable accessory 12 takes the form of a backpack 14 including a pair of shoulder straps 16 and 18 having buckle adjustments 20 and 22. The wearable accessory 12 in the form of the backpack 14 may be viewed as gender-specific, such as for a boy, particularly if it is blue in color. (A backpack for a girl may as well be provided.) FIG. 2 shows the backpack 14 being worn by a child 24, held within close proximity to an adult 26 by means of a detachable tether 28, while FIG. 3 shows the backpack 14 being worn by itself. The tether 28 is useful when traveling with young children, particularly in busy public places.

The terminology “extended use” as employed herein is intended to mean that the wearable accessory 12, embodied as the backpack 14, can be worn by the child 24 in combination with the tether 28 when the child is relatively young, for example, within the age range eighteen months to approximately four years; and also worn later when the child 24 is relatively older, for example, beyond approximately four years of age, without use of the tether 28.

Thus, the backpack 14, notwithstanding its utility as a way to attach the tether 28, has a stylish appearance such that a relatively younger child, seeing relatively older children wearing such backpacks without tethers, feels more comfortable in wearing the accessory 12. In other words, when the child 24 is tethered, the appearance of the device 10 encourages the child 24 to feel as if he (or she) is wearing a “big boy” (or a “big girl”) accessory. Moreover, once the child 24 has outgrown the need for a tether, or is in a situation where use of the tether 28 is not required, the accessory 12 can continue to be used (extended use), thus prolonging the useful life of the accessory 12.

The backpack 14 of FIGS. 1-3, as conventional backpack features, includes on the rear side 30 thereof a main storage compartment 32 with a zipper closure 34, a secondary storage compartment 36 with a zipper closure 38, and a rear elastic pouch 40. On the left side of the main storage compartment 32 is an elastic pouch 42 which secures a water bottle 44. The backpack 14 has a front surface 46 which, during use, is against the back of the child 24, and to which the shoulder straps 16 and 18 are attached to support the backpack 14 in a conventional manner.

The device 10 also includes a harness, generally designated 50. As alternatives, the harness 50 comprises simply the shoulder straps 16 and 18, or, preferably, the harness 50 also comprises additional elements which are not necessarily part of the wearable accessory 12. Thus, for further security, as an additional harness element 52, a lateral strap 52 interconnects the shoulder straps 16 and 18 across the chest of the child 24, and includes an adjustment buckle 54. For still further security, and as another additional harness element 56, a removable belt 56 including a buckle 58 is provided. For securing the belt 56 to the backpack 14, a belt loop 60 through which the belt 56 passes is sewn to the front surface 46 near the lower end thereof. The buckle 58 facilitates removal and attachment of the belt 56. A utility storage pouch 62 is secured to the belt 56.

It will be appreciated that the shoulder straps 16, 18, the lateral strap 52, and the belt 56 together secure the wearable accessory 12 to the child 24, generally in the manner of a usual backpack harness, and more securely than some backpack harnesses.

Near the top of the backpack 14 is an attachment 76 for the tether 28, in the form of a ring 78 secured by a short web 80 of material sewn to the body of the backpack 14. The tether 28 includes a corresponding hook 90 at its near end for removable attachment to the ring 78, as well as a handle loop 92 at its distal end.

Thus, the tether 28 is detachable, and is employed when the child 24 is relatively younger. As noted above, the backpack 14 is worn by itself when the child 24 is relatively older, and the tether 28 is not employed. The backpack 14 may also be worn by a younger child without the tether 28 in situations, other than busy public places, where it is less necessary to keep the child 24 close. The backpack 14 with its included harness 66 accordingly also serves the functions of a real backpack, quite apart from its function to support the attachment ring 78 for the detachable tether 28.

In FIG. 3, which shows the backpack 14 being worn by itself, the belt 56 (FIGS. 1 and 2) part of the harness 66 is not employed, but the shoulder straps 16 and 18, as part of the wearable accessory 12 itself, are employed. However, when the backpack 14 is being worn by itself, without use of the tether 28, the belt 56 can be employed if desired.

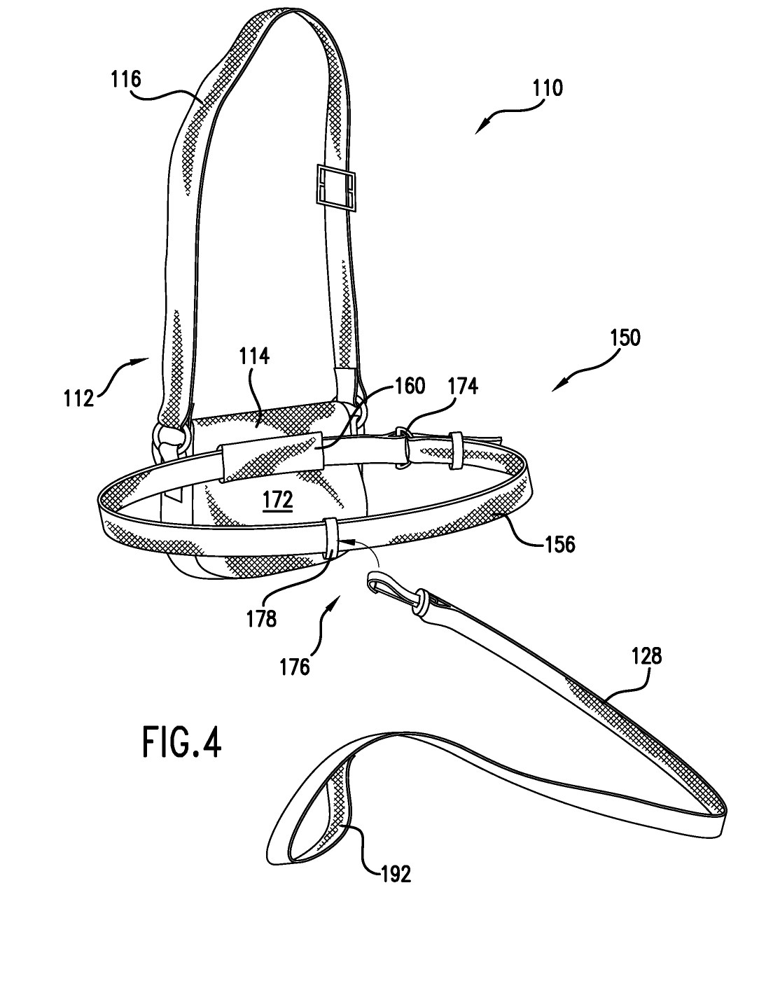

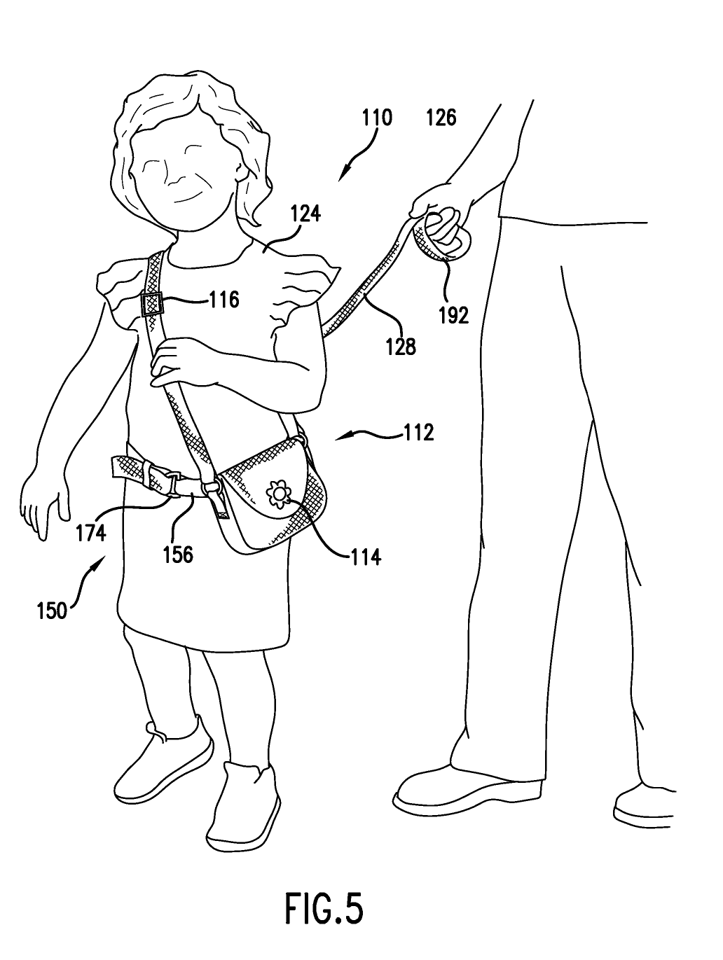

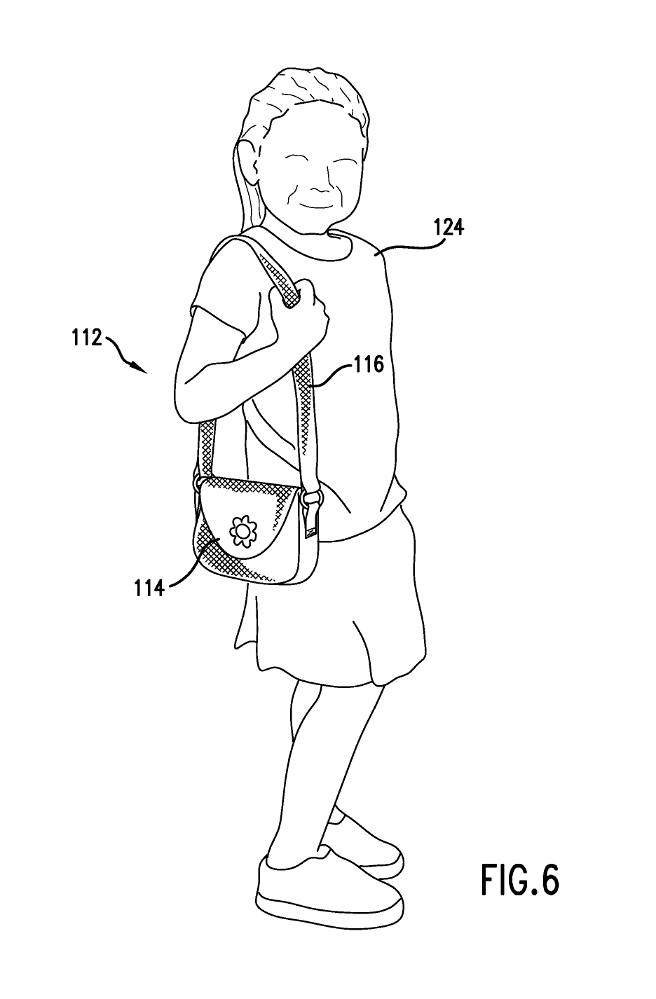

Referring next to FIGS. 4-6, another convertible tether device for a child is generally designated 110. The device 110 includes a wearable accessory 112 suitable for extended use by a relatively older child. In the embodiment of FIGS. 4-6, the wearable accessory 112 takes the form of a purse 114 including a shoulder strap 116. The wearable accessory 112 embodied as the purse 114 may be viewed as gender-specific, such as for a girl. FIG. 5 shows the device 110 including the purse 114 being worn by a child 124, held within close proximity to an adult 126 by means of a tether 128, while FIG. 6 shows the purse 114 being worn by itself. As in the embodiment of FIGS. 1-3, the tether 128 is useful when traveling with young children, particularly in busy public places.

The device 110 also includes a harness, generally designated 150. Thus, included as part of the device 110 in general, but not as part of the wearable accessory 112 itself, is a harness element 156 in the form of a belt 156. The shoulder strap 116 and the harness element 156 or belt 156 together comprise the harness 150. For securing the harness element or belt 156 to the purse 114, a belt loop 160 (FIG. 4) through which the belt 156 passes is sewn to the rear side 172 of the purse 114. A buckle device 174 facilitates removal and attachment of the belt 156.

The tether 128 is removably attachable to the device 110. More particularly, in the embodiment of FIGS. 4-6, on the belt 156 is an attachment 176 for the tether 128, in the form of an attachment loop 178 or ring 178 (FIG. 4). The tether 128 includes a corresponding hook 190 at its near end for removable attachment to the loop 178, as well as a handle loop 192 at its distal end.

During use with the tether 128 as illustrated in FIG. 5, the harness element or belt 156 is employed, and the shoulder strap 116 is placed over the opposite shoulder compared to the side of the child 124 where the purse 114 itself is located. The shoulder strap 116 and belt 156 accordingly cooperate as the harness 150. When the purse 114 is worn without use of the tether 128 as illustrated in FIG. 6, the harness element or belt 156 is not employed, and the shoulder strap 116 is positioned on either side, as desired.

Thus, the purse 114, notwithstanding its possible use in combination with the tether 128, has a stylish appearance such that a relatively younger girl, seeing relatively older girls or adult women carrying purses, feels more comfortable in wearing the accessory 112 including the purse 114. In other words, when the child 124 is tethered, the appearance of the device 110 encourages the child 124 to feel as if she is wearing a “big girl” accessory. In that regard, the belt 156, although functioning as part of the harness 150, has the appearance of an ordinary belt. The harness element 156 and shoulder strap 116 as part of the purse 114, taken together, have a stylish appearance, not readily recognizable as a harness. Thus, the shoulder strap 116 has the appearance of and actually is a shoulder strap, the harness element 156 has the appearance of a fashion belt, and the purse 114 has both the appearance and function of a purse in which the girl 124 can store articles as desired. Moreover, once the child 124 has outgrown a need for a tether, or is in a situation where use of the tether 128 is not required, the purse 114 can continue to be used, thus prolonging the useful life of the purse 114 (extended use).

The device 110 of FIGS. 4-6 differs from the device 10 of FIGS. 1-3 in that, in the device 10 of FIGS. 1-3, the harness 50 (including the shoulder straps 16, 18, and the lateral strap 52, but not necessarily the belt 56) is part of the wearable accessory 12. In the device 110 of FIGS. 4-6, the harness element 156 (the belt 156) part of the harness 150 is not part of the actual wearable accessory 112, that is, of the purse 112, although the shoulder strap 116 is part of the wearable accessory 112.

While specific embodiments have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. A convertible travel tether device for a child, comprising:
a wearable accessory suitable for extended use by a relatively older child;
said wearable accessory including a harness for securing said accessory to the child; and
a detachable tether;
whereby said detachable tether is employed when the child is relatively younger, and said wearable accessory is worn by itself when the child is relatively older without use of said tether.

2. The device of claim 1, wherein said harness includes at least one additional element which is not part of said wearable accessory when said wearable accessory is worn by itself.

3. The device of claim 1, wherein said wearable accessory is gender-specific.

4. The device of claim 1, wherein said wearable accessory comprises a backpack.

5. A convertible travel tether device for a child, comprising
a wearable accessory suitable for extended use by a relatively older child;
a harness element attachable to said accessory for securing said accessory to the child; and
a detachable tether;
whereby said detachable tether is employed when the child is relatively younger, and said wearable accessory is worn by itself when the child is relatively older without use of said tether.

6. The device of claim 5, wherein said wearable accessory is gender-specific.

7. The device of claim 5, wherein said wearable accessory comprises a purse.
